(19) United States
(12) Patent Application Publication
(10) Pub. No.: US 2020/0057605 A1
(43) Pub. Date: Feb. 20, 2020

(54) SYSTEM AND METHOD FOR MONITORING DELIVERY OF GOODS

(71) Applicant: ROADWAREZ INC., LAKEWOOD, NJ (US)

(72) Inventor: YESHAYA KRISPIN, LAKEWOOD, NJ (US)

(21) Appl. No.: 16/662,056

(22) Filed: Oct. 24, 2019

Related U.S. Application Data
(63) Continuation-in-part of application No. 16/175,975, filed on Oct. 31, 2018.
Application No. 16/175,975 is a continuation of application No. 15/393,292, filed on Dec. 29, 2016, now Pat. No. 10,133,548.
Application No. 15/393,292 is a continuation-in-part of application No. 15/113,831, filed on Jul. 24, 2016, now Pat. No. 10,399,627.
(60) Provisional application No. 62/273,480, filed on Dec. 31, 2015.
(60) Provisional application No. 62/075,914, filed on Nov. 6, 2014.
(60) Provisional application No. 61/965,255, filed on Jan. 27, 2014.
(60) Provisional application No. 62/750,861, filed on Oct. 26, 2018.

(51) Int. Cl. G06F 3/16; G06F 1/16; H04W 4/90; H04N 5/232; G05D 1/10; B64D 47/08; G01S 19/13; B64C 39/02; G08B 25/01; G08B 5/00; H04B 1/3827

(52) U.S. Cl. CPC G06F 3/167; G06F 1/163; H04W 4/90; H04N 5/23206; G05D 1/102; B64D 47/08; G06F 3/048; B64C 39/024; G08B 25/016; G08B 25/012; G08B 5/002; H04B 1/385; G01S 19/13

(57) ABSTRACT

A system and method for monitoring collection and delivery of goods using a wearable delivery monitor. A location tracker module tracks the location, collection, and delivery, and a goods tracking monitor module records transfer of the goods. Data from the delivery monitor is communicated to a management server which verifies that the transfer has been carried out correctly.

### CROSS-REFERENCE TO RELATED APPLICATIONS

This application is a Continuation-In-Part of U.S. patent application Ser. No. 16/175,785, filed Oct. 31, 2018, which is a Continuation of U.S. patent application Ser. No. 15/393,292, filed Dec. 29, 2016, which is a Continuation-In-Part of U.S. patent application Ser. No. 15/113,831, filed Jul. 24, 2016, which is a U.S. National Phase Application under 35 U.S.C. 371 of International Application No. PCT/IB2015/050567, which has an international filing date of Jan. 26, 2015, and which claims priority and benefit from U.S. Provisional Patent Application No. 61/965,255, filed Jan. 27, 2014, and U.S. Provisional Patent Application No. 62/075,914, filed Nov. 6, 2014.

U.S. patent application Ser. No. 16/175,785 further claims priority and benefit from U.S. Provisional Patent Application No. 62/273,480, filed Dec. 31, 2015. The contents and disclosures of the above-identified applications are incorporated herein by reference in their entirety.

This application further claims priority and benefit from U.S. Provisional Patent Application No. 62/750,861, filed Oct. 26, 2018, the contents of which are incorporated by reference in their entirety.

### FIELD AND BACKGROUND

The disclosure herein relates to systems and methods for monitoring delivery of goods. There is a need for monitoring and confirming delivery of goods in real time. The invention described herein addresses the above-described needs.

### SUMMARY

According to one aspect of the presently disclosed subject matter, there is provided a system and method for monitoring the transfer of goods. The system may include a wearable item comprising a micro-processor, and a communication interface; a location tracker module operable to track the current location of the wearable item, the tracker module configured to provide location based data; and a goods tracking monitor module operable to record and confirm delivery of goods being delivered, the goods tracking monitor module may be configured to provide delivery data. Optionally, the goods tracking monitor module comprises a scanner. Additionally or alternatively, the goods tracking monitor comprises a camera. Variously, the camera is selected from a group of cameras consisting of a front camera, a back camera, a side camera and combinations thereof.

Where appropriate, the system may further include a delivery management server comprising: a delivery database storing data pertaining to required deliveries; a delivery data receiver operable to receive the location based data from the location tracker and goods data, such as the delivery data from the goods tracking monitor; and a verification module operable to compare data received by the data receiver with data stored in the delivery database. Optionally, the delivery management server further comprises a notification module operable to communicate with a delivery agent.

Additionally or alternatively, the system may further include a collection management server comprising: a collection database storing data pertaining to required collections; a collection data receiver operable to receive the location based data from the location tracker and goods data such as collection data from the goods tracking monitor; and a verification module operable to compare data received by the data receiver with data stored in the collection database.

Where appropriate, the system may further include a communication manager operable to communicate location based data and goods data to a management server.

Where appropriate, the wearable item may comprise the location tracker module. Optionally, the location tracker module comprises a satellite navigation system. Additionally or alternatively, the location tracker module is configured to communicate with an external satellite navigation system.

The system may further include a third-party identification module operable to record a third-party receiving delivered goods. Additionally or alternatively, the third-party identification module operable to record a third-party transferring collected goods. Accordingly, the third-party identification module may include: an imaging device operable to capture an image of a subject; and an image recognition module operable to identify the subject captured by the image.

According to another aspect of the presently disclosed subject matter a method is taught for recording transfer of goods. The method may include: providing a wearable item comprising a micro-processor, and a communication interface, a location tracker module, and a goods tracking monitor module; a delivery agent wearing the wearable item; the delivery agent making a delivery of goods; the location tracker module recording location based data indicating the location of the wearable item when the goods are delivered; and the goods tracking monitor module recording the goods being delivered.

Furthermore, the method may further include, communication interface communicating the location based data to a delivery management server; the communication interface communicating delivery data from the goods tracking monitor to the delivery management server; and the communication interface receiving a notification from the delivery management server. Variously, the notification from the delivery management server may comprise: receiving a verification that the delivery is delivered to a correct address or alternatively a notification that the delivery is delivered to an incorrect address.

Additionally or alternatively, the method may further comprise: a delivery management server receiving the location based data from the location tracker module; the delivery management server receiving delivery data from the goods tracking monitor; and the delivery management server comparing the location based data and the delivery data with data stored in a delivery database.

Optionally, the method may further comprise: a collection management server receiving the location based data from the location tracker module; the collection management server receiving collection data from the goods tracking monitor; the delivery management server comparing the location based data and the collection data with data stored in a collection database.

### BRIEF DESCRIPTION OF THE DRAWINGS

For a better understanding of the embodiments and to show how it may be carried into effect, reference will now be made, purely by way of example, to the accompanying drawings.

With specific reference now to the drawings in detail, it is stressed that the particulars shown are by way of example and for purposes of illustrative discussion of selected embodiments only, and are presented in the cause of providing what is believed to be the most useful and readily understood description of the principles and conceptual aspects. In this regard, no attempt is made to show structural details in more detail than is necessary for a fundamental understanding; the description taken with the drawings making apparent to those skilled in the art how the several selected embodiments may be put into practice. In the accompanying drawings:

FIG. 1 schematically represents a delivery agent, wearing a delivery monitor, collecting a goods package from a first party and delivering the goods package to a second party;

FIG. 2 schematically represents a delivery monitoring system according to aspects of the current disclosure; and

FIG. 3 is a flowchart representing a method for monitoring transfer of goods according to other aspects of the current disclosure.

### DETAILED DESCRIPTION

Aspects of the present disclosure relate to systems and methods for monitoring transfer of goods. In particular the present disclosure relates to wearable technology including monitors such as video cameras or the like operable to record collection, transit and delivery of goods in real time.

In various embodiments of the disclosure, one or more tasks as described herein may be performed by a data processor, such as a computing platform or distributed computing system for executing a plurality of instructions. Optionally, the data processor includes or accesses a volatile memory for storing instructions, data or the like. Additionally or alternatively, the data processor may access a non-volatile storage, for example, a magnetic hard-disk, flash-drive, removable media or the like, for storing instructions and/or data.

It is particularly noted that the systems and methods of the disclosure herein may not be limited in its application to the details of construction and the arrangement of the components or methods set forth in the description or illustrated in the drawings and examples. The systems and methods of the disclosure may be capable of other embodiments, or of being practiced and carried out in various ways and technologies.

Alternative methods and materials similar or equivalent to those described herein may be used in the practice or testing of embodiments of the disclosure. Nevertheless, particular methods and materials are described herein for illustrative purposes only. The materials, methods, and examples are not intended to be necessarily limiting.

### Description of the Embodiments

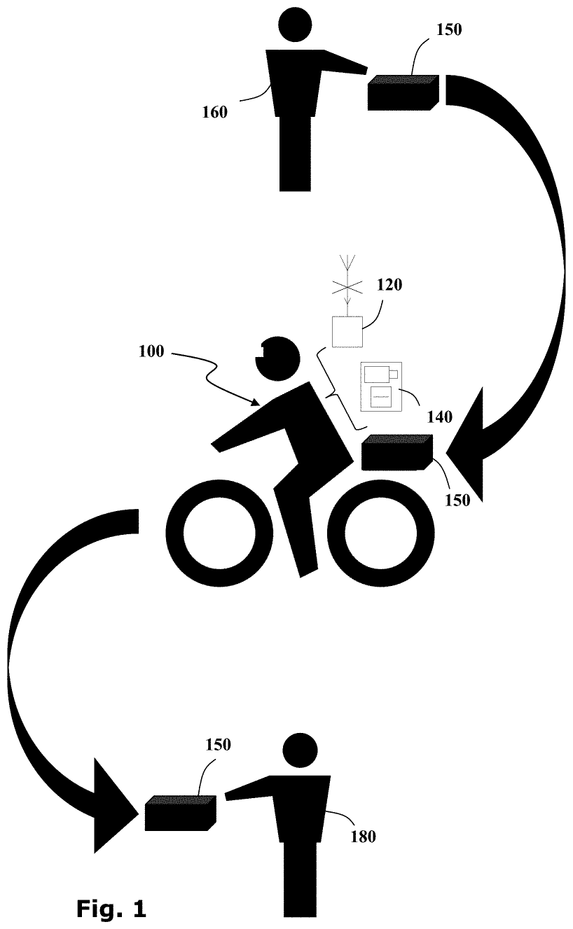

Referring now to FIG. 1, a delivery agent wearing a wearable delivery monitor 100 may deliver a goods package 150 from a first party 160 to a second party 180. The wearable delivery monitor 100 includes a location tracker 120 and a goods tracking monitor 140. The delivery monitor 100 may be used for recording the transfer of goods at either or both of the collection point and the delivery point.

It is noted that a monitor 140, such as a video camera or the like, may be integrated into an item of clothing. The item of clothing, such as a jacket, coat, helmet, hat spectacles, pants, bag, backpack, watch, shoe or the like as well as combinations thereof may be worn by a delivery agent. The monitor 140 may further be in communication with a location tracker 120 such as included in the platform described in U.S. patent application Ser. No. 15/113,831 and U.S. Pat. No. 10,133,548 which are incorporated herein in their entirety.

Accordingly, the wearable item 100 may locate the delivery agent and the monitor 120 and may be automatically triggered to record data upon collection and delivery of the goods 150 for example when the delivery worker arrives at the delivery address. A camera may record the whole process of delivery or collection as a video which may be used to confirm delivery or collection and to indicate the location of the delivery if required.

Where appropriate the recorded data may be processed and sent to the delivery company and/or the customer as required. In particular where nobody is available to receive the delivered item, automatically captured video data may be used to provide evidence of such.

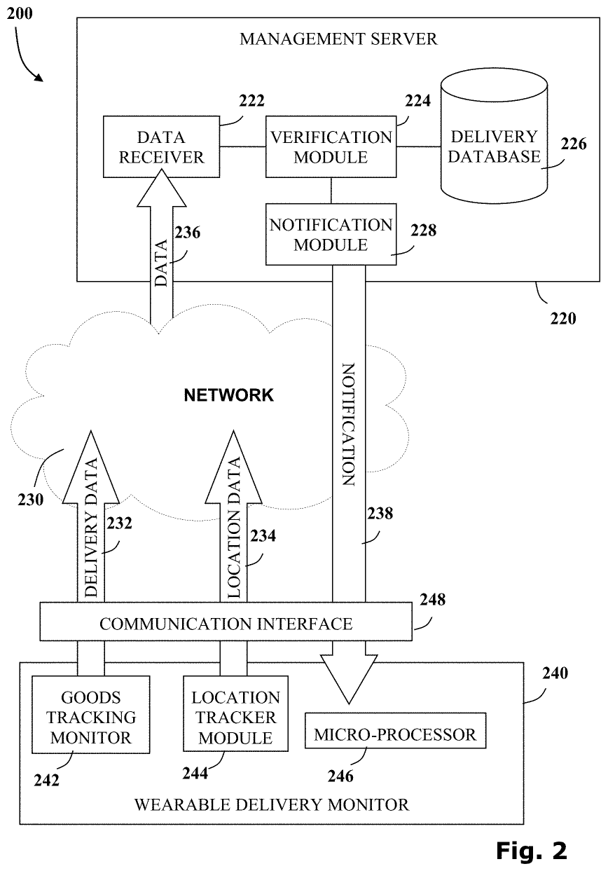

Referring now to FIG. 2, a delivery monitoring system 200 may further include a delivery monitor 240 integrated into a wearable item and a management server 220 connected via a communication channel such as a computer network 230.

The wearable delivery monitoring system 240 includes a goods tracking monitor 242, a location tracker 244 and a micro-processor 246. The system 240 is in communication with the management system via a communication interface 248.

The location tracker module 244, such as a satellite navigation unit, a cellular network or the like, is operable to track the current location of the wearable item 240. The location tracker module 244 is configured to provide location based data which is communicated to the management server.

The goods tracking monitor 242 is operable to record and confirm delivery of goods being delivered. The goods tracking monitor 242 is configured to provide delivery data. For example, the goods tracking monitor 242 may comprise a scanner or a camera or the like.

The micro-processor 246 is operable to coordinate and control the delivery monitor 240.

The management server 220 includes a data receiver 222, a verification module 224 in communication with a delivery database 226 and a notification module 228.

The delivery database 226 is configured and operable to store data pertaining to required deliveries.

The data receiver 222 is configured and operable to receive goods data 236 including the location based data 234 from the location tracker 244 and delivery data 232 from the goods tracking monitor 242.

The verification module 224 is configured and operable to compare data 236 received by the data receiver 222 with data stored in the delivery database 226. Optionally, the delivery management server 220 further comprises a notification module 228 operable to communicate notifications 228 to the delivery agent via the delivery monitor 240.

Various features of the system may enable more efficient and secure transfer of goods by monitoring both the collection and delivery of those goods. For example, the camera may be operable to identify or scan a code, such as an alphanumeric code, a bar code, a QR code or the like, which may be included with the item to be delivered, possibly using an integrated image recognition mechanism. Accordingly, the monitor may use the code to confirm that the corresponding items are delivered to the correct delivery address or receiver.

A communication manager may be operable to ensure that data, such as image data, location data, identification data and combinations thereof, may be communicated via a communication agent in real time to the delivery company which may automatically or manually confirm delivery details with the details stored on a delivery management server or database. The system may send a confirmation notification to the delivery agent to continue to the next delivery address. Additionally or alternatively if the recorded monitor data do not match the stored details, a corrective instruction or query may be sent to the delivery agent. Where required, a delivery worker may be prompted to contact a delivery manager for clarification before proceeding to the next delivery.

In other aspects the disclosure teaches a method for efficient and safe dispensing and delivery of prescription drugs. A pharmacy or drug dispenser may send prescription drugs using a delivery agent, such as an external delivery service provider.

Using a delivery monitoring system such as described herein, the delivery may be confirmed to be to the correct destination and even to the correct individual to be receiving the drugs.

A delivery agent collecting the drugs from a pharmaceutical supplier may perform a collection protocol including video comparison between the collected package and the original prescription issued by a medical practitioner to a patient according to local regulations. Such a confirmation mechanism may allow the prescription medicines to be validated and confirmed upon the point of collection such that any discrepancies or inaccuracies may be identified in real time at the point of collection. Where required, a request for clarification or query may be sent to the medical practitioner, who may authorize the amended instructions.

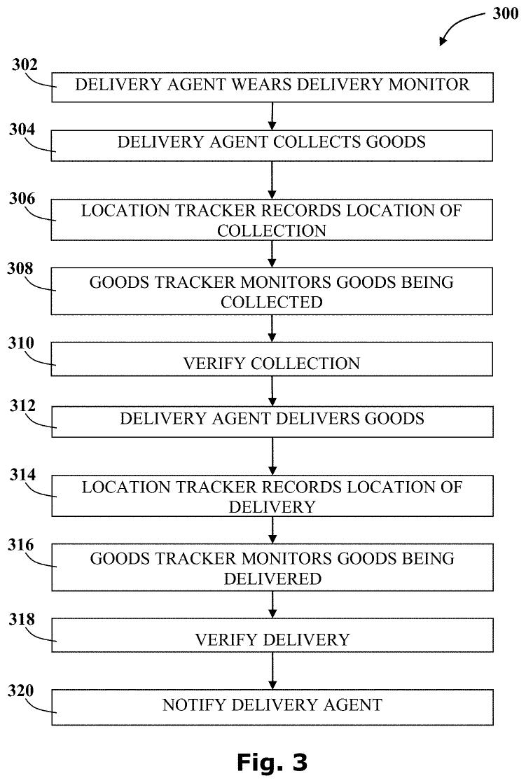

Referring now to the flowchart of FIG. 3, selected actions are presented of a method 300 for monitoring transfer of goods according to other aspects of the current disclosure.

A delivery agent wears a wearable delivery monitor 302 and collects goods 304. At the point of collection, the location tracker records the location of the collection 306 and the goods tracker monitors and records the goods being collected 308. Optionally, the monitor may further record and identify the collecting party from whom the goods are collected. According to the data gathered during collection, the collection may be verified.

Having collected the goods, the delivery agent may deliver the goods 310 to a receiving party 312. At the point of delivery, the location tracker records the location of the delivery 314 and the goods tracker monitors and records the goods being delivered 316. Optionally, the monitor may further record and identify the receiving party. According to the data gathered during delivery 318, the collection may be verified, and a suitable notification may be relayed to the delivery agent 320.

Technical and scientific terms used herein should have the same meaning as commonly understood by one of ordinary skill in the art to which the disclosure pertains. Nevertheless, it is expected that during the life of a patent maturing from this application many relevant systems and methods will be developed. Accordingly, the scope of the terms such as computing unit, network, display, memory, server and the like are intended to include all such new technologies a priori.

As used herein the term “about” refers to at least ±10%.

The terms “comprises”, “comprising”, “includes”, “including”, “having” and their conjugates mean “including but not limited to” and indicate that the components listed are included, but not generally to the exclusion of other components. Such terms encompass the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” may include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments or to exclude the incorporation of features from other embodiments.

The word “optionally” is used herein to mean “is provided in some embodiments and not provided in other embodiments”. Any particular embodiment of the disclosure may include a plurality of “optional” features unless such features conflict.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween. It should be understood, therefore, that the description in range format is merely for convenience and brevity and should not be construed as an inflexible limitation on the scope of the disclosure. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6 as well as non-integral intermediate values. This applies regardless of the breadth of the range.

It is appreciated that certain features of the invention, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

Although the invention has been described in conjunction with specific embodiments thereof, it is evident that other alternatives, modifications, variations and equivalents will be apparent to those skilled in the art. Accordingly, it is intended to embrace all such alternatives, modifications, variations and equivalents that fall within the spirit of the invention and the broad scope of the appended claims.

Additionally, the various embodiments set forth hereinabove are described in term of exemplary block diagrams, flow charts and other illustrations. As will be apparent to those of ordinary skill in the art, the illustrated embodiments and their various alternatives may be implemented without confinement to the illustrated examples. For example, a block diagram and the accompanying description should not be construed as mandating a particular architecture, layout or configuration.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a computer-readable medium such as a storage medium. Processors may perform the necessary tasks.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present disclosure. To the extent that section headings are used, they should not be construed as necessarily limiting.

The scope of the disclosed subject matter is defined by the appended claims and includes both combinations and sub combinations of the various features described hereinabove as well as variations and modifications thereof, which would occur to persons skilled in the art upon reading the foregoing description.

What is claimed is:

1. A system for monitoring delivery comprising:
a wearable item comprising a micro-processor, and a communication interface;
a location tracker module operable to track the current location of the wearable item, said tracker module configured to provide location based data; and
a goods tracking monitor module operable to record and confirm delivery of goods being delivered, said goods tracking monitor module configured to provide delivery data.

2. The system of claim 1 further comprising a delivery management server comprising:
a delivery database storing data pertaining to required deliveries;
a delivery data receiver operable to receive said location based data from said location tracker and said delivery data from said goods tracking monitor; and
a verification module operable to compare data received by said data receiver with data stored in said delivery database.

3. The system of claim 1 wherein said delivery management server further comprises a notification module operable to communicate with a delivery agent.

4. The system of claim 1 further comprising a collection management server comprising:
a collection database storing data pertaining to required collections;
a collection data receiver operable to receive said location based data from said location tracker and collection data from said goods tracking monitor; and
a verification module operable to compare data received by said data receiver with data stored in said collection database.

5. The system of claim 1 further comprising a communication manager operable to communicate said location based data and said delivery data to a management server.

6. The system of claim 1 wherein said goods tracking monitor comprises a camera.

7. The system of claim 6, wherein said at least one camera is selected from a group of cameras consisting of a front camera, a back camera, a side camera and combinations thereof.

8. The system of claim 1, wherein said wearable item comprises said location tracker module.

9. The system of claim 1, wherein said location tracker module comprises a satellite navigation system.

10. The system of claim 1, wherein said location tracker module is configured to communicate with an external satellite navigation system.

11. The system of claim 1 wherein said goods tracking monitor module comprises a scanner.

12. The system of claim 1 further comprising a third-party identification module operable to record a third-party receiving delivered goods.

13. The system of claim 1 further comprising a third-party identification module operable to record a third-party transferring collected goods.

14. The system of claim 1 comprising a third-party identification module comprising:
an imaging device operable to capture an image of a subject; and
an image recognition module operable to identify the subject captured by said image.

15. A method for recording delivery of goods, the method comprising:
providing a wearable item comprising a micro-processor, and a communication interface, a location tracker module, and a goods tracking monitor module;
a delivery agent wearing said wearable item;
said delivery agent making a delivery of goods;
said location tracker module recording location based data indicating the location of the wearable item when said goods are delivered; and
said goods tracking monitor module recording said goods being delivered.

16. The method of claim 15, further comprising:
said communication interface communicating said location based data to a delivery management server;
said communication interface communicating delivery data from said goods tracking monitor to said delivery management server; and
said communication interface receiving a notification from said delivery management server.

17. The method of claim 16, wherein receiving said notification from said delivery management server comprises: receiving a verification that said delivery is delivered to a correct address.

18. The method of claim 16, wherein receiving said notification from said delivery management server comprises: receiving a correction that said delivery is delivered to an incorrect address.

19. The method of claim 15, further comprising:
a delivery management server receiving said location based data from said location tracker module;
said delivery management server receiving delivery data from said goods tracking monitor;
said delivery management server comparing said location based data and said delivery data with data stored in a delivery database.

20. The method of claim 15, further comprising:
a collection management server receiving said location based data from said location tracker module;
said collection management server receiving collection data from said goods tracking monitor;
said delivery management server comparing said location based data and said collection data with data stored in a collection database.
